(19) United States
(12) Patent Application Publication
(10) Pub. No.: US 2008/0257307 A1
(43) Pub. Date: Oct. 23, 2008

(54) Converting an electronic fuel injection engine to a carbureted engine

(76) Inventor: Scott R. Minch, Livonia, MI (US)

Correspondence Address: THE WEINTRAUB GROUP, P.L.C., Suite 240, 32000 Northwestern Highway, Farmington Hills, MI, 48334, US

(21) Appl. No.: 12/080,909

(22) Filed: Apr. 7, 2008

Related U.S. Application Data
(60) Provisional application No. 60/922,015, filed on Apr. 5, 2007.

(51) Int. Cl. F02D 41/00

(52) U.S. Cl. 123/357; 123/497

(57) ABSTRACT

An apparatus and method for converting the fuel management system of a conventional OEM internal combustion engine from electronic fuel injection to a carbureted fuel delivery system whereby to increase performance of the engine over a narrow range of power output needs. In use, the EFI system is removed from the cylinder head and a specially configured intake adapter manifold is mounted thereto and a carburetor system is seated atop the adapter manifold, the adapter manifold and carburetor system having fuel delivery passages that pass air/fuel mixtures from one or more carburetors of the carburetor system to respective cylinders of the engine head.

### CROSS-REFERENCE TO RELATED APPLICATION

This application is a completion application of and claims the benefit of U.S. Provisional Application No. 60/922,015, filed Apr. 5, 2007, the entire disclosure of which is incorporated herein in its entirety.

### BACKGROUND OF THE INVENTION

1. Field of the Invention

The present invention is directed to a method and apparatus for converting the fuel management system of a conventional OEM internal combustion engine utilizing electronic fuel injection to a carbureted fuel delivery system, and more particularly, to an adapter manifold for use in accomplishing this conversion.

2. Description of the Prior Art

For many years the fuel management system of the conventional spark-driven internal combustion engine has used a carburetor to deliver fuel into the engine. In recent years, the fuel delivery system has undergone a change wherein the carburetor has been replaced by electronic fuel injection (“EFI”). One primary reason was the increasing imposition of state engine emission control standards and fuel economy on engines.

A carburetor is considered a wet-flow fuel-metering device. The gasoline is discharged through a booster venturi where it's atomized and emulsified (broken down into small particles and mixed with air, respectively). From there, the mixture undergoes a phase change from a liquid (albeit in small particles) to a gas. The phase change requires heat and is called vaporization. For this to occur efficiently, it's important for the fuel to be atomized as much as possible and for the emulsification process to be thorough.

In contrast, EFI uses an injector to atomize the gasoline. This is accomplished through high pressure (in relation to a carburetor) that forces the fuel through either a small hole or series of holes in the injector tip. The fuel is then mixed with the air already in the manifold runner, and the vaporization event takes places. An EFI system is considered a dry-flow design since only air travels through the majority of the length of the intake-manifold runner.

Whatever system is being used, the engine has no idea of how it's being fueled. The gasoline, along with the combustion event, can't tell if an EFI system or a carburetor is attached to the intake manifold. What does impact the engine is what happens to the charge-defined as the air/fuel mixture-on its way to the intake valve.

The engine does not breathe in a linear fashion and thus a higher rpm does not always mean higher cylinder-fill rates. A carburetor handles this by nature of its design. It provides fuel flow in lock step with air throughput. EFI needs to monitor the airflow of the engine to then calculate the amount of fuel to create a desired air/fuel ratio.

The major argument for fuel injection is lower emissions, better gas mileage, smoother operation, consistent power, and better overall engine control. Depending on the application, airflow and fuel metering, a carburetor fuel management system can deliver more peak power than the EFI system. A carburetor's pressure differential atomizes the fuel better than spraying fuel through an orifice. Further, the carburetor system is simpler than an EFI system and can be worked on by nearly anyone with a screwdriver and a set of socket wrenches. The EFI system tends to be very complex and requires special tools and equipment to work on them.

On average, if optimized, both systems perform about the same. However, in a narrow range of power output needs, the carburetor fuel management system may provide the stock car enthusiast with a distinct advantage over the EFI system. However, such cars are not currently being manufactured and apparatus and methods for the conversion of the EFI fuel management systems are needed.

Accordingly, an object of this invention is to provide the racing enthusiast with a means wherein the EFI fuel management system, originally provided on the internal combustion engines of automobiles in recent years, may be converted and the EFI system replaced with a carburetor system.

### SUMMARY OF THE INVENTION

The present invention discloses an adapter intake manifold used to convert 4.6 liter and 5.4 liter displacement gasoline engines from electronic fuel injection management style fuel delivery systems to single and multiple carbureted fuel delivery systems.

According to this invention, there is provided an improvement for use in a multi-cylinder internal combustion engine of the spark ignition type including a cylinder head having a plurality of cylinders arranged into a V-shape and adapted for use with an electronically controlled fuel management system (“EFI”), the cylinders having their openings arranged in two rows in side by side relation and opening on a mounting face of the cylinder head, the improvement comprising means for converting the EFI system into a carburetor fuel management system, the means for converting including

an intake manifold including lower and upper mounting surfaces and a plurality of first fuel passages, the lower surface being adapted to be secured to the mounting face of the cylinder head, the upper mounting surface being formed by a pair of raised housings separated by a medial plate portion, and the fuel passages being disposed in side by side relation in one and the other of said raised housings and extending between the respective mounting surfaces of the intake manifold, and

a carburetor system comprising a carburetor housing having a lower first and an upper second surface and a mounting bracket and a series of second passages extending between the surfaces thereof, at least one carburetor, and means for securing the carburetor atop the carburetor housing, the lower first surface being adapted to be secured atop the upper mounting surface of the intake manifold in a manner that the second fuel passages register with a respective of said first fuel passages, and the carburetor having an outlet adapted to deliver a proper air/fuel mixture to the second passages when mounted atop the bracket.

Also and according to this invention, there is provided an improvement for use in a multi-cylinder internal combustion engine of the spark ignition type including a cylinder head having a plurality of cylinders arranged into a V-shape and using a fuel management system of the type comprising an electronically controlled fuel injection device (“EFI system”) including a plurality of separate fuel injectors that in operation control the amount, duration and time of fuel that is supplied into a respective cylinder, the improvement comprising a method for converting the fuel management system from an EFI system to a carburetor system, the steps including

removing the EFI system, wherein the cylinders of the cylinder head are upwardly open,

providing an intake manifold, the manifold including upper and lower surfaces and a plurality of like-shaped first fuel passages that extend between the respective surfaces of the manifold, the lower surface being adapted to mount to the cylinder head and the upper surface forming a V-shaped well,

replacing the EFI system with the carburetor system, the carburetor system including a carburetor housing and a carburetor, said carburetor housing having a lower first surface configured for seated nesting into the V-shaped well, an upper second surface, and a plurality of second fuel passages extending between the first and second surfaces, and said carburetor mounted to said carburetor housing and having a fuel inlet for receiving fuel, an air intake for receiving air, means for vaporizing the air and fuel into a proper air/fuel mixture, and an outlet for discharging and distributing the air/fuel mixture into the second fuel passages,

fixedly securing lower surface of the intake manifold atop and in sealed relation against the cylinder head in a manner that the first fuel passages and the cylinder openings register with one another, and

fixedly securing the carburetor system atop the intake manifold in a manner that the housing is in sealed relation against the upper surface of the intake manifold, the first and second fuel passages register with one another, and the carburetor outlet is in fluid communication with the second fuel passages.

Further an according to this invention, there is provided an adapter manifold for mounting to a cylinder head of an internal combustion engine, the cylinder head configured for operation with electronic fuel injection delivery and having at least two rows of cylinder bores having their openings disposed on a mounting face of the cylinder head, the adapter manifold comprising a one-piece rectangular shaped body cast from a metal and having lower and upper mounting surfaces, a pair of raised housings and a pair planar plate portions connecting the housings in laterally spaced relation, and a plurality of passages in each said housing and extending between the surfaces, the lower surface being configured for securement atop the mounting face of the cylinder head and to register the passages and cylinder bore with one another when the adapter is secured to the cylinder head, and the upper surface formed by the housings and plate portions forming a recess within which a carburetor fuel delivery system is nested in a manner that the passages are disposed for communicating an air/fuel mixture from the carburetor to the cylinder bores.

Preferably, in the conversion apparatus and the method of practicing the conversion according to this invention, the multi-cylinder engine includes eight cylinders, that are arranged in two rows of four each, the mounting faces of the intake manifold and the cylinder head are generally flat, the mating upper surface of the intake manifold and lower mounting surface of the bracket are formed, in part, by angled sections which abut against one another and properly orient the carburetor during the securing steps, and the passages are arranged in two rows of four each for communicating an air/fuel mixture from the carburetor into the cylinders.

Preferably, each laterally spaced raised housing has an angled sidewall, the sidewalls are facing, and the passages extend from the lower mounting surface open on the angled sidewall.

In one preferred embodiment, the passages in the intake manifold are generally rectangular shaped.

Preferably, the intake manifold includes a pair of cylindrical coolant passages, each coolant passage registering with a corresponding coolant bore in the cylinder head.

In another preferred embodiment, the carburetor system includes two carburetors for delivering an air/fuel mixture to the fuel passages of the intake manifold.

The present invention will be more clearly understood with reference to the accompanying drawings and to the following Detailed Description, in which like reference numerals refer to like parts and where:

### BRIEF DESCRIPTION OF THE DRAWINGS

FIG. 1 is a plan view looking down on the a top mating face of a cylinder head of an internal combustion engine configured for use with an electronic fuel delivery system;

FIG. 2 is a perspective view looking down on an adapter manifold for mounting atop the cylinder head of FIG. 1 and converting the engine for use with a carburetor fuel delivery system; and

FIG. 3 is a view looking down at a carburetor system positioned for securement atop the adapter manifold of FIG. 2 whereby to communicate an air/fuel mixture from each of two carburetors to the cylinders of the cylinder head.

### DETAILED DESCRIPTION OF THE PREFERRED EMBODIMENT

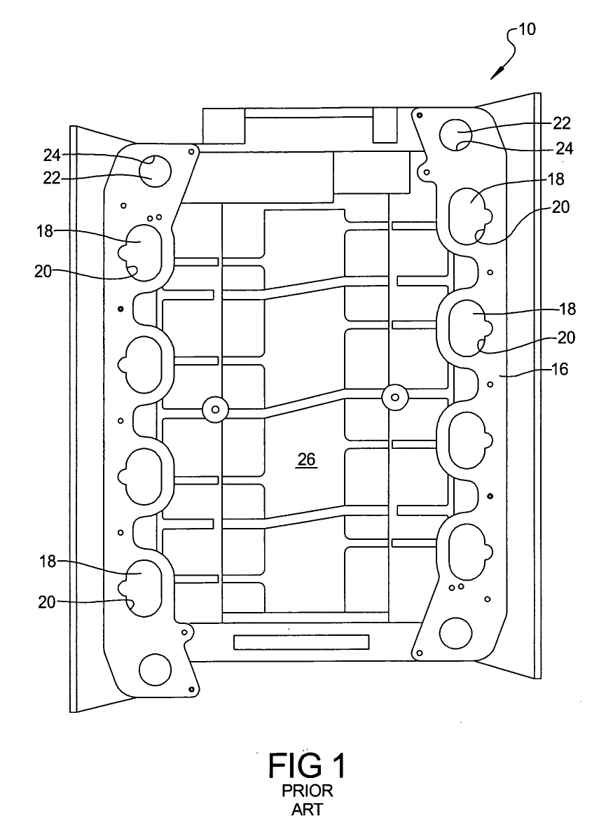

Turning now to the drawings, FIG. 1 illustrates the top of a cylinder head, generally indicated by the reference number 10, of an internal combustion engine (not shown) of the spark ignition type and utilizing an electronic fuel injection (“EFI”) system (not shown). In general, the cylinders are arranged into a V-shape and each receives a separate fuel injector that, in operation, controls the amount, duration and time of fuel that is supplied into each respective cylinder.

In general, a complete OEM EFI system includes a manifold, a set of fuel injectors, one injector for each cylinder, a throttle body, a fuel rail and a fuel connection, a computer and a control system, wire harness and the like. In the practice of the invention, the user will remove all of these elements of the EFI system, leaving the cylinder head 10.

In FIG. 1, the elements of the EFI system have been removed from the cylinder head 10. Further, the EFI system is not illustrated herein and will not be discussed in detail because the system is conventional and understood by those skilled in the art and also because the elements are removed and form no part of this invention.

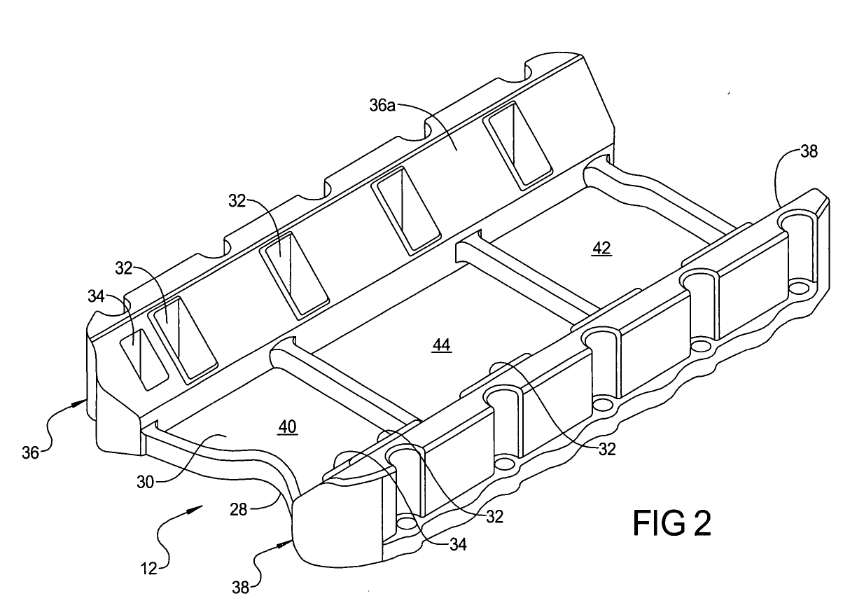

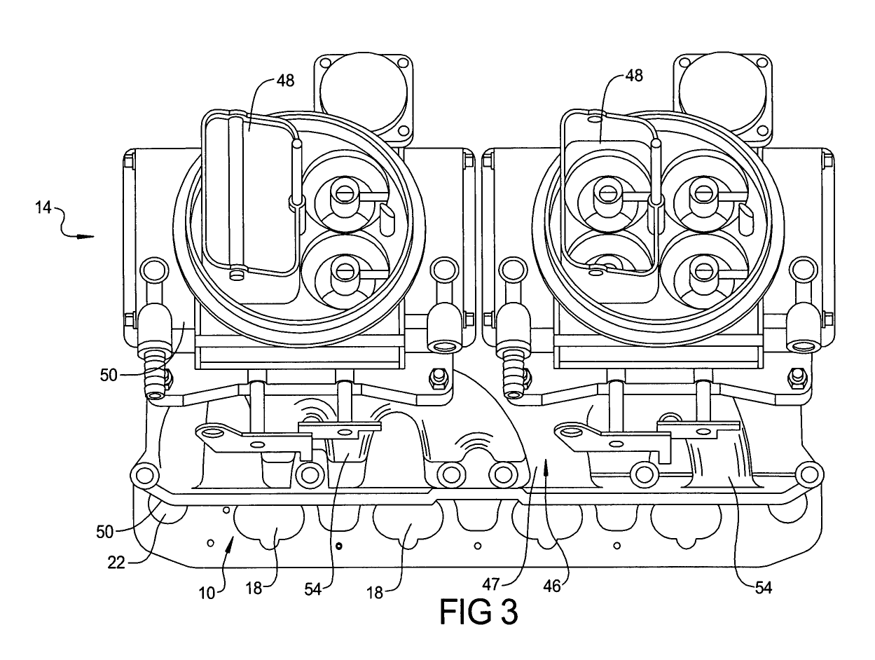

As will be described herein below, according to this invention, an adapter manifold 12, as shown in FIG. 2, and a carburetor system 14, as shown in FIG. 3, are assembled to the cylinder head 10. In so doing, the internal combustion engine is converted from one using an EFI fuel delivery system to one using a carbureted system. In the embodiment illustrated in FIG. 2, the adapter manifold 12 converts electronic fuel injection system on Ford model 4.6 liter and 5.4 liter internal combustion engines for years 1999 and newer. Desirably, this enables the conversion herein to use vintage single and multiple carbureted intake manifolds

The cylinder head 10 includes an upper mating face 16, two rows of cylinders 18 each with a respective opening 20 on the mating face, a pair of coolant ports 22 each with a respective opening 24 on the mating face and disposed at the end of a respective row, and a central hollow 26. The cylinder head 10 is specifically configured for receiving parts of the electronic fuel injection (“EFI”) system, including individual fluid injectors that are positioned within the respective cylinders for introducing a controlled amount of gas for burning.

The intake or adapter manifold 12 comprises a one-piece generally rectangular shaped body cast from a metal, such as iron, steel, or aluminum. The manifold 12 includes lower and upper mounting surfaces 28 and 30, a plurality of fuel passages 32, and a pair of coolant fluid passages 34. The lower surface 28 is generally planar and is adapted to be secured to the mounting face 16 of the cylinder head 10. The upper mounting surface 30 is formed by a pair of raised housings 36 and 38 laterally separated by a pair of medial rectangular shaped plate portions 40 and 42.

The housings 36 and 38 extend axially between the opposite ends of the adapter manifold 12 and project upwardly from a horizontal plane including the plate portions 40 and 42. Each housing 36 and 38 includes an angled sidewall 36a and 38a that is at an acute angle of about 40°-50° to the horizontal plane including the plate portions 36 and 38. The housings 36 and 38 and plate portions 40 and 42, as will be described herein below, form a recess or cradle within which the carburetor system 14 may nest or be seated. Further, a rectangular shaped opening 44 is formed between the plate portions 40 and 42 for receiving a lower portion of the carburetor system 14, if needed.

The passages 32 and 34 are formed into two rows, each row including four fuel passages 32 and one coolant passage 34. The passages 32 and 34 in each row are linearly disposed in side by side relation and positioned such that the fuel passages 32 and coolant passage 34 in each row align with corresponding of the cylinder openings 20 and coolant ports 22 on the cylinder head 10.

The passages 32 and 34 are generally rectangular shaped and extend between the mounting surfaces 28 and 30. Further, the passages 32 and 34 terminate on the angled sidewalls 36a and 38a and the passages 32 form inlet openings for receiving air/fuel from the carburetor system 14.

The carburetor system 14 comprises a carburetor housing 46 and at least one carburetor 48. The carburetor housing 46 has lower and upper surfaces 50 and 52, a mounting bracket 47, and a series of second passages 54 that extend through the housing and between the surfaces 50 and 52. The lower surface 50 of the bracket 47 is adapted to be secured atop the upper mounting surface 30 of the intake manifold 12 in a manner that the second passages 54 register with a respective of the fuel passages 32 on the sidewalls 36a and 38a.

The intake manifold 12 forms, with the plate portion(s) and housing segments 36 and 38, a truncated V-shaped well for receiving and within which the carburetor system 14 is nested. The lower surface 50 of the carburetor housing 46 and bracket 47 thereof includes oppositely angled surface portions that seat against the angled sidewalls 36a and 38a of the adapter manifold 12 to seat the carburetor system 14 atop the housing 46 in snug nested relation therewith when mounted atop the bracket.

The carburetor 48 is conventional and includes a fuel inlet for receiving fuel, an air intake for receiving air, means for vaporizing the air and fuel into a proper air/fuel mixture, and an outlet for discharging the air/fuel. The carburetor is mounted atop the bracket by any conventional mounting technique known by those skilled in the art. When mounted, the carburetor outlet is registered with the series of passages 54 in the mounting bracket 46.

In the embodiment illustrated, two carburetors 48 are provided atop the mounting bracket 46.

In practice, the adaptor manifold 12 is installed inserting factory OEM gaskets and fasteners to the intake port side or upper mating face 16 of the cylinder head 10. Appropriate mounting flanges or lugs on the cylinder head and adapter manifold are aligned, bolted together using 1.00×35 mm bolts and torqued to factory specifications.

A second set of factory OEM gaskets is installed on the top side of the adaptor manifold, which provides introduction of a vintage single or multiple carbureted intake manifold fitment specifically from a 289 or 302 cubic inch displacement (“CID”) engine.

The adaptor manifold accepts the vintage manifold and appropriate gaskets, which are bolted to the adaptor manifold using 5/16″×2″ factory fasteners. The rpm and throttle of the 4.6 liter and 5.4 liter fuel injected combustion engines are now controlled thru vintage carburetion systems instead of computer-managed fuel injection with the fitment of the adaptor manifold.

The adapter manifold, when bolted to the cylinder head 16, forms a tight seal for the combustion chamber. The passages 34 allow coolant to carry away heat from areas of high temperature.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

What I claim is:

1. In a multi-cylinder internal combustion engine of the spark ignition type including a cylinder head having at least one cylinder arranged for use with an electronically controlled fuel management system (“EFI system”), the cylinder opening on a mounting face of the cylinder head, the improvement comprising means for converting the EFI system into a carburetor fuel management system, the means for converting including:
an intake adapter manifold including lower and upper surfaces and at least one first fuel passage that extends between the surfaces of the manifold,
first means for connecting the lower surface atop the mounting face of the cylinder head and in a manner that the first fuel passage and cylinder are registered with one another,
a carburetor system, said carburetor system including a housing having upper and lower surfaces and at least one second fuel passage that extends between the surfaces of the housing and a carburetor having fluid and air inlets and an outlet for delivering an air/fuel mixture to the first fuel passage of the adapter manifold,
second means for connecting the lower surface of the housing atop the top surface of the adapter manifold in a manner that the second and first fuel passages are registered with one another, and
third means for connecting the carburetor atop housing in a manner that the outlet of the carburetor and second fuel passage are registered with one another.

2. The improvement of claim 1, further wherein the carburetor housing and adaptor manifold and cylinder head of said engine include a plurality of first and second fuel passages and cylinders that register with one another.

3. The improvement of claim 2, wherein said cylinder head, adapter manifold, and carburetor housing include third air passages for removing and replacing air heated by the engine during operation with coolant air.

4. The improvement of claim 2, further wherein the first and second fuel passages and cylinders are disposed in first and second rows in side be side relation to one another.

5. The improvement of claim 3, wherein said adapter manifold includes a pair of axially extending housing segments and a medial plate portion, the segments being laterally spaced by the plate portion to form a well for nesting the carburetor housing.

6. The improvement of claim 4, wherein each said housing segment has an angled support surface, the plate portion and support surfaces forming in elevation a truncated V-shape for supporting and nesting the carburetor housing.

7. The improvement of claim 2, wherein the cylinder head, adapter manifold, and carburetor housing each include eight first and second fuel passages and eight cylinders arranged in two rows of four each.

8. The improvement of claim 6, wherein the first fuel passages are generally rectangular in shape and open on the support surfaces of the respective housing segments.

9. The improvement of claim 1, further wherein said carburetor system includes two carburetors, and means for distributing a proper air fuel mixture from said carburetors into the fuel passages of the intake manifold.

10. The improvement of claim 6, wherein the support surfaces are at an acute angle of about 40°-50° relative to a horizontal including the plate portion.

11. An apparatus for converting an internal combustion engine having an electronic fuel injection delivery system (“EFI system”) with a carburetor fuel delivery system (“carburetor system”), the engine including a cylinder head having at least two rows of cylinder bores that open on the cylinder head, the apparatus comprising:
an adapter manifold, the adapter manifold replacing the EFI system and comprising a one-piece rectangular shaped body cast from a metal and having lower and upper surfaces, a pair of raised housings, a planar plate portion connecting the housings in laterally spaced relation, and a plurality of first fuel passages, the housings each having an angled surface that combine to form with the plate portion a truncated V-shaped nest, the passages extending between the surfaces, the lower surface being configured for mounting atop the cylinder head and in a manner to register the passages and cylinder bores with one another, and
a carburetor system, the carburetor system including a carburetor housing and at least one carburetor mounted to the housing, the carburetor housing having a lower first and an upper second surface, and a plurality of second fuel passages extending between the surfaces thereof, the carburetor having an outlet for distributing an air/fuel mixture to the second passages, and the lower first surface conforming to the shape of the V-shaped nest and for conformable seating therewithin and in manner that the second fuel passages are registered with the first fuel passages and communicate air/fuel mixtures from the carburetor to the cylinder bores.

12. In a multi-cylinder internal combustion engine of the spark ignition type including a cylinder head having a plurality of cylinders arranged into a V-shape and using a fuel management system of the type comprising an electronically controlled fuel injection device (“EFI system”) including a plurality of separate fuel injectors that in operation control the amount, duration and time of fuel that is supplied into a respective cylinder, the improvement comprising a method for converting the fuel management system from an EFI system to a carburetor system, the steps including:
removing the EFI system, wherein the cylinders of the cylinder head are upwardly open,
providing an intake manifold, the manifold including upper and lower surfaces and a plurality of like-shaped first fuel passages that extend between the respective surfaces of the manifold, the lower surface being adapted to mount to the cylinder head and the upper surface forming a V-shaped well,
replacing the EFI system with the carburetor system, the carburetor system including a carburetor housing and a carburetor, said carburetor housing having a lower first surface configured for seated nesting into the V-shaped well, an upper second surface, and a plurality of second fuel passages extending between the first and second surfaces, and said carburetor mounted to said carburetor housing and having a fuel inlet for receiving fuel, an air intake for receiving air, means for vaporizing the air and fuel into a proper air/fuel mixture, and an outlet for discharging and distributing the air/fuel mixture into the second fuel passages,
fixedly securing lower surface of the intake manifold atop and in sealed relation against the cylinder head in a manner that the first fuel passages and the cylinder openings register with one another, and
fixedly securing the carburetor system atop the intake manifold in a manner that the housing is in sealed relation against the upper surface of the intake manifold, the first and second fuel passages register with one another, and the carburetor outlet is in fluid communication with the second fuel passages.
